(19) United States
(12) Patent Application Publication
(10) Pub. No.: US 2026/0230409 A1
(43) Pub. Date: Aug. 6, 2026

(54) Enhanced NWDAF-Assisted Application Detection based on External Input

(71) Applicant: TELEFONAKTIEBOLAGET LM ERICSSON (PUBL), Stockholm (SE)

(72) Inventors: Gonzalo Hernandez Haro, Madrid (ES); Maria Luisa Mas Rosique, Tres Cantos (ES); Carlota Villasante Marcos, Madrid (ES); Victor Gomez-Hidalgo Perez, Torrijos Toledo (ES); Antonio Camas Maestre, Madrid (ES); Miguel Angel Muñoz De La Torre Alonso, Madrid (ES)

(21) Appl. No.: 19/156,485

(22) PCT Filed: Mar. 16, 2023
(86) PCT No.: PCT/IB2023/052592

§ 371 Date: Aug. 14, 2025

(30) Foreign Application Priority Data
Feb. 14, 2023 (EP) 23382135.4

(51) Int. Cl. H04L 43/026; H04L 41/14

(52) U.S. Cl. CPC H04L 43/026; H04L 41/14

(57) ABSTRACT

Embodiments include methods, in a network data analytics function, NWDAF, for discovering and/or updating packet flow descriptions, PFDs, for network analytics in a wireless communication network. An example method comprises receiving (710), from a network analytics consumer, a request related to assisted application detection, and triggering (720) data collection by an application function, AF, from one or more entities external to the wireless communication network, responsive to the request, by sending traffic characteristics related to at least one packet data flow. The example method further comprises receiving (730), from the AF, data obtained by the AF from the one or more entities and corresponding to the traffic characteristics and, based on the data, deriving (740) one or more new and/or updated packet flow descriptions and responding (750) to the request with analytics results including an indication of the new and/or updated packet flow descriptions.

### TECHNICAL FIELD

The present disclosure relates generally to communication networks, and more specifically to techniques for discovering and/or updating packet flow descriptions (PFDs) for network analytics in a wireless communication network.

### BACKGROUND

Currently the fifth generation (“5G”) of cellular systems, also referred to as New Radio (NR), is being standardized within the Third-Generation Partnership Project (3GPP) and deployed. NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) includes an Access Network (AN) and a Core Network (CN). The AN provides UEs connectivity to the CN, e.g., via base stations such as gNBs or ng-eNBs described below. The CN includes a variety of Network Functions (NFs) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via respective interfaces 102, 152. More specifically, gNBs can be connected to one or more Access and Mobility Management Functions (AMFs) in the 5GC via respective NG-C interfaces. Similarly, gNBs can be connected to one or more User Plane Functions (UPFs) in the 5GC via respective NG-U interfaces. Various other network functions (NFs) can be included in the 5GC, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can provide coverage in the respective cells via various directional beams.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane (UP) transport and signaling transport.

The NG RAN nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs are logical nodes that host higher-layer protocols and perform various gNB functions such controlling the operation of DUs. DUs are logical nodes that host lower layer protocols and can include various subsets of the gNB functions. As such, CUs and DUs can include various circuitry needed to perform their respective functions, including processing circuitry, communication interface circuitry, power supply circuitry, etc.

A gNB-CU connects to one or more gNB-DUs over respective F1 logical interfaces, such as interfaces 122 and 132 shown in FIG. 1. However, a gNB-DU can be connected to only one gNB-CU, with the gNB-CU and connected gNB-DU(s) visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify.” In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

A Network Data Analytics Function (NWDAF) provides network analytics information (e.g., statistical information of past events and/or predictive information) to other NFs. The NWDAF can also perform storage and retrieval of analytics information from an Analytics Data Repository Function (ADRF).

Indirect communication in SBA was specified in 3GPP Rel-16 , using a Service Communication Proxy (SCP) as a standardized proxy between Service Consumers and Service Producers. 3 GPP Rel-17 enhanced SBA with a Data Management Framework that includes a Data Collection Coordination Function (DCCF) and an optional messaging framework. Data consumers ask DCCF for data collection in relation to a data producer. The DCCF subscribes to the data source (if it does not have a subscription already) and then coordinates the request and data delivery, e.g., using the messaging framework. The data producer inputs the requested data to the messaging framework, which delivers the data to the data consumer.

FIG. 2 shows an exemplary architecture of a 5G network (200) with service-based interfaces, providing some context for the operation of the NWDAF and the SCP. The architecture shown in FIG. 2 includes the following NFs:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the Session Management Function (SMF) via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)-supports handling of user plane (UP) traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems. Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs. In 5G, the NEF may comprise a Packet Flow Description Function (PFDF), which was previously a standalone function. The PFDF is intended to manage the PFDs (Packet Flow Descriptors) provided by Application Service Providers (ASPs) and distribute them to the SMFs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—provides network analytics information (e.g., statistical information of past events and/or predictive information) to other NFs on a network slice instance level.
Location Management Function (LMF) with Nlmf interface
supports various functions related to determination of UE locations, including location determination for a UE and obtaining any of the following: DL location measurements or a location estimate from the UE; UL location measurements from the NG RAN; and non-UE associated assistance data from the NG RAN.
The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR).
In addition to the UDM, the Unified Data Repository (UDR) supports storage and retrieval of policy data by the PCF, as well as storage and retrieval of application data by NEF.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3 GPP Rel-17 enhances the SBA by adding a Data Management Framework that includes a Data Collection Coordination Function (DCCF) and a messaging framework, which is defined in detail in 3GPP TR 23.700-91 (v 17.0.0) section 6.9. The Data Management Framework is backward compatible with a Rel-16 NWDAF function, described above.

For Rel-17, the baseline for services offered by the DCCF (e.g., to an NWDAF Analytics Function) are the Rel-16 NF Services used to obtain data. For example, the baseline for the DCCF service used by an NWDAF consumer to obtain UE mobility data is Namf_EventExposure. The 5G system architecture also allows any NF to obtain analytics from an NWDAF using a DCCF function and associated Ndccf services. The NWDAF can also perform storage and retrieval of analytics information from an Analytics Data Repository Function (ADRF).

A Rel-16 NWDAF can coexist with a Rel-17 NWDAF and the Data Management Framework. A Rel-16 NWDAF continues to request data directly from NFs without using the Data Management Framework and provides analytics to consumers that discover the Rel-16 NWDAF. A Rel-17 NWDAF can request data from the Data Management Framework, and if the data is not collected already, the Data Management Framework would request the data from a data source. In other words, a data source would independently send Data to the Rel-16 NWDAF that sent a request directly to the data Source, and to the Data Management Framework that sent a request for the Rel-17 NWDAF.

In Rel-17, the NWDAF is decomposed by moving Data Collection (including the task of identifying the Data Source) to the Data Management Framework. The Rel-17 NWDAF requests data from the Data Management Framework but may not query other NFs (e.g., NRF, UDM, etc.) to determine which NF instance serves a UE, nor need it be concerned about life cycles of Data Source NFs, as was the case for Rel-16 NWDAF. This decomposition also allows other NFs to obtain data via the Data Management Framework and avoids duplicate data collection from the same data source. The Rel-17 NWDAF (without Data Collection) may be referred to as the “NWDAF Analytics Function.”

FIG. 3 illustrates a high-level view of the Rel-17 Data Management Framework. The main components are the DCCF (330) that communicates with other NFs, the Messaging Framework, and a Data Repository. The DCCF optionally includes a DCCF Adaptor (DA) used to communicate with the Messaging Framework, which optionally includes a Consumer Adaptor (3CA) and/or a Producer Adaptor (3PA) used to communicate with a Data Consumer (310) and a Data Source (340), respectively. The DA, 3CA, and 3PA may be standalone or combined with the DCCF, Data Consumer, and Data Source, respectively. Exemplary Data Consumers include the NWDAF Analytics Function an NF requesting analytics, but as with other NF services, nothing precludes other Consumer NFs. The Data Management Framework is compatible with both a 3GPP-defined Data Repository Function for ML/Analytics and Data Repositories that are not 3GPP-defined.

DCCF is a control-plane function that coordinates data collection and triggers data delivery to Data Consumers. A DCCF may support multiple Data Sources, Data Consumers, and Message Frameworks. However, to prevent duplicate data collection, each Data Source is associated with only one DCCF. DCCF provides the 3GPP defined Ndccf_DataExposure Service to Data Consumers and uses the services of Data Sources to obtain data. Although FIG. 3 shows one DCCF for the 5GC, there can be multiple DCCF instances associated with different network slices, different geographic regions where Data Sources reside, or different types of Data Sources. A DCCF registers with NRF and is discovered by Consumers (or SCP) using the registration and discovery procedures defined for the NF Service Framework in 3GPP TS 23.502(v16.7.0 ).

DCCF receives data requests from Data Consumers via the Ndccf_DataExposure service. If a Data Source is not specified in the Data Request, DCCF determines the Data Source that can provide the data requested by the Data Consumer. For example, if the request is for UE-specific data, DCCF may query the other NFs (320, e.g., NRF, UDM, etc.) to determine which NF instance is serving the UE. If the Data Source is specified in the Data Request (e.g., the Data Consumer is configured with Data Sources), DCCF checks whether the data is already collected from the Data Source. If not, DCCF will request the data from the specified Data Source. If the requested data is partially covered by existing subscriptions with the Data Source, the DCCF sends a request to the Data Source to modify one or more subscriptions to accommodate both the previous requests for data and the new request for data. Additionally, DCCF may determine if the requested data is currently being produced by any Data Source and being provided to the Messaging Framework. If the requested data is not being produced and/or provided, DCCF sends a new subscription/request towards the Data Source to trigger a new data collection, and DCCF then subscribes with the messaging framework for the Data Consumer to receive future notifications associated with the desired Data Source.

While the Messaging Framework is not standardized by 3GPP, a Messaging Framework Adaptor NF (MFAF) offers 3GPP-defined services that allow the 5GS to interact with the Messaging Framework. Internally, the Messaging Framework may for example support a pub-sub pattern, where received data are published to the Messaging Framework and requests from 3GPP Consumers result in Messaging Framework specific subscriptions. Alternatively, the Messaging Framework may support other protocols outside of the scope of 3GPP.

DCCF uses the Nmfaf_3daData Management service to convey information so that the Messaging Framework can recognize data that are received from a Data Source. The MFAF can obtain data received by the Messaging Framework, process and format the data according to instructions for each consumer/notification endpoint, and send notifications or responses to the Data Consumers.

When data is received (e.g., due to event notification), the Messaging Framework processes it according to the formatting and processing instructions for each consumer/notification endpoint before sending the respective notifications. Note that notifications sent via the Nmfaf_3caDataManagement service have the same content as those sent via a Ndccf_DataManagement service for data delivery via the DCCF.

The Nnwdaf_DataManagement service enables consumers to subscribe/unsubscribe for data/analytics produced by NWDAF, be notified about data exposed by NWDAF, or fetch the subscribed data. It enables consumers to request generation of bulk data for Event IDs and/or Analytics IDs and to retrieve the requested data.

More specifically, the Nnwdaf_DataManagement_Subscribe service operation of the Nnwdaf_DataManagement service enables consumers to subscribe to receive data or historical analytics (which is regarded as a kind of data). If the data is already defined in NWDAF, then the subscription is updated. The required service operation inputs include Data Specification or Analytics Specification, Notification Target Address, and Notification Correlation ID.

When the required data is a bulk data for Event IDs received from NFs, the Data Specification includes a set of Event IDs, Event Filter Information, Target of Event Reporting, and bulk data type. When the required data is a bulk data for Analytics ID, the Data Specification includes Target of Reporting with the set of Analytics ID(s) to generate bulk data, bulk data type, analytics stage, Filter Information with Target of Analytics Information, and Analytics Filter Information. These parameters are further defined in 3 GPP 23.288(v17.3.0 ) section 6.2.6.1.

When the required data is historical analytics, the Analytics Specification is included in the required input parameters and identifies the historical analytics to be collected, based on Analytics ID(s), Target of Analytics Reporting, Analytics Filter information and other input parameters for NWDAF services. These parameters are further defined in 3 GPP 23.288 (v17.3.0) sections 7.2 and 7.3.

### SUMMARY

There are several problems with current network analytics processes in 5G. Some arise from current encryption trends, which make it difficult to derive new/updated PFDs for the so-called known applications scenario, based on UPF traffic analysis. Likewise, processes for the unknown applications scenario are not developed.

The techniques described herein extend the analytics related to NWDAF-assisted application detection by triggering data collection from a new entity (acting as AF intermediary), which will hide the complexity towards external entities that might provide information relative to application traffic, such as Google Play Store, Apple App Store, Microsoft Store, Internet Assigned Numbers Authority (IANA) registries, Google Search, etc.

Example embodiments include methods, in a network data analytics function, NWDAF, for discovering and/or updating packet flow descriptions, PFDs, for network analytics in a wireless communication network. An example method comprises receiving, from a network analytics consumer, a request related to assisted application detection, and triggering data collection by an application function, AF, from one or more entities external to the wireless communication network, responsive to the request, by sending traffic characteristics related to at least one packet data flow. The example method further comprises receiving, from the AF, data obtained by the AF from the one or more entities and corresponding to the traffic characteristics and, based on the data, deriving one or more new and/or updated packet flow descriptions and responding to the request with analytics results including an indication of the new and/or updated packet flow descriptions.

Other example embodiments include methods, in an application function (AF), for supporting the discovery of and/or updating of packet flow descriptions (PFDs) for network analytics in a wireless communication network. An example of such a method comprises receiving, from a network data analytics function (NWDAF), a request for data collection by the AF from one or more entities external to the wireless communication network, the request including traffic characteristics related to at least one packet data flow. The example method further comprises selecting one or more entities external to the wireless communication network, based on the traffic characteristics, sending a query for data corresponding to the traffic characteristics to each selected entity, and sending data retrieved from each selected entity to the NWDAF.

Other embodiments include NWDAFs or AFs (or network nodes hosting the same) that are configured to perform the operations corresponding to any of the exemplary methods described herein. Other embodiments also include non-transitory, computer-readable media storing computer-executable instructions that, when executed by processing circuitry associated with such NWDAFs and/or AFs, configure the same to perform operations corresponding to any of the exemplary methods described herein.

These and other embodiments described herein improve the existing mechanism for NWDAF assisted application detection for both the “known” and “unknown” application scenarios.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 illustrates a high-level view of the 3 GPP Rel-17 Data Management Framework.

FIG. 4A and FIG. 4B each shows a signaling diagram for NWDAF assisted application detection according to some embodiments.

FIG. 5 illustrates an example of information returned from a query to an external entity.

FIG. 6 is another example of information returned from a query to an external entity

FIG. 7 shows an exemplary method (e.g., procedure) for an NWDAF of a communication network, according to various embodiments of the present disclosure.

FIG. 8 shows an exemplary method (e.g., procedure) for an AF of a communication network, according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

FIG. 14 illustrates communication between a host computing system, a network node, and a UE via multiple connections, according to various embodiments of the present disclosure.

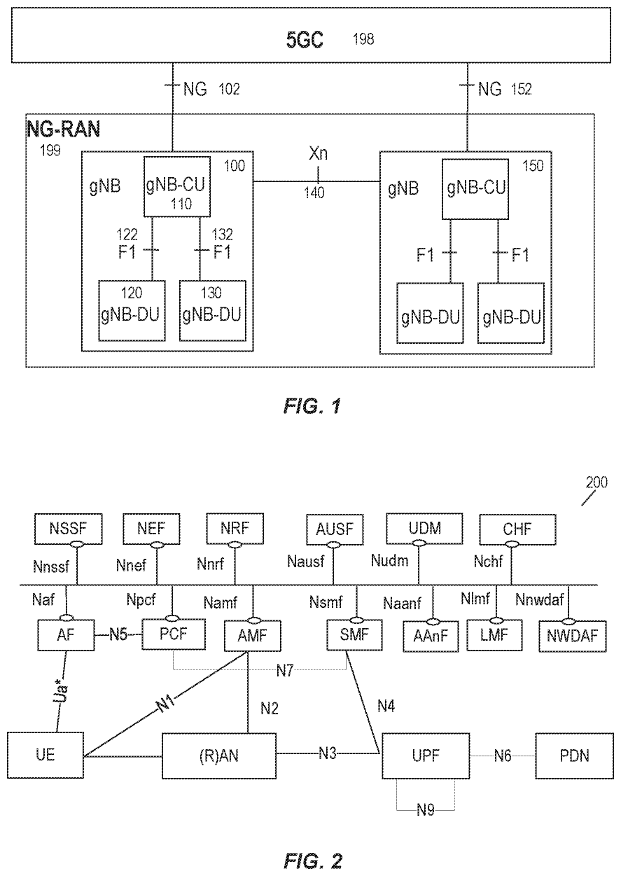

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Definitions of some terms that may be used throughout the description are given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device.
Service: As used herein, the term “service” refers generally to a set of data, associated with one or more applications, that is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, such, concepts described herein apply equally to both cells and beams.

Above, various components of the 5G network architecture were described. The most relevant architectural aspects for this invention include the NWDAF (Network Data Analytics Function), ADRF (Analytics Data Repository Function), NEF (PFDF), UDR, PCF, SMF, and UPF.

Reviewing these briefly, the NWDAF is an operator managed network analytics logical function. The NWDAF is part of the 5GC architecture and uses the mechanisms and interfaces specified for 5GC and Operations Administration and Maintenance (OAM). The NWDAF interacts with different entities for different purposes:
data collection based on event subscription, provided by AMF, SMF, PCF, UDM, AF (directly or via NEF), and OAM;

retrieval of information from data repositories (e.g., UDR via UDM for subscriber-related information);
retrieval of information about NFs (e.g., NRF for NF-related information, and NSSF for slice-related information);
on-demand provision of analytics to consumers.

The ADRF (Analytics Data Repository Function) is a massive storage for two types of data: collected data (e.g., Event Exposure data), and analytics reports.

The NEF (PFDF) supports different functionality and specifically in the context of this disclosure, NEF supports different Exposure APIs, e.g., NEF API for Packet Flow Description (PFD) management. Here, PFD management refers to the capability to create, update or remove PFDs in the NEF (PFDF), as well as to distribute the PFDs from the NEF (PFDF) to the SMF and finally to the UPF. This feature may be used when the UPF is configured to detect a particular application provided by an ASP.

The UDR stores data grouped into distinct collections of subscription-related information: Subscription Data; Policy Data; Structured Data for Exposure; and Application Data.

The PCF supports a unified policy framework to govern the network behavior. Specifically, the PCF provides PCC (Policy and Charging Control) rules to the PCEF (Policy and Charging Enforcement Function), i.e., the SMF/UPF that enforces policy and charging decisions according to provisioned PCC rules.

The SMF supports different functionalities, e.g., the SMF receives PCC rules from the PCF and configures the UPF accordingly.

The UPF supports handling of user plane traffic, including packet inspection, packet routing and forwarding, traffic usage reporting, QoS handling for user plane (e.g., UL/DL rate enforcement). The UPF may receive PFDs from the AF through the NEF and SMF. The SMF receives the PFD from the NEF and convert it to applications and filters in Packet Detection Rules Records (PDRs) to be sent to the UPF.

A PFD is a set of information enabling the detection of application traffic. Each PFD may be identified by a PFD ID. A PFD ID is unique in the scope of a particular application identifier. Conditions for when PFD ID is included in the PFD are described in 3GPP TS 29.551. There may be different PFD types associated to an Application Identifier. A PFD includes a PFD ID and
one or more of the following:
3-tuple(s) including protocol, server-side IP address and port number;
the significant parts of the URL to be matched, e.g., host name;
a Domain name matching criteria and information about applicable protocol(s), e.g., the Domain Name Service (DNS) protocol.

Several problems with network analytics handling in 5G networks have been identified:
Rel-18 eNAPh3(3GPP TR 23.700-81) intends to enhance 3GPP enablers for Network Automation (eNA) specified functionality (see 3GPP TS 23.288v17.6.0 , September 2022).

According to current agreements, the normative phase will only focus on the “known applications” scenario. This implies that a solution for the “unknown applications” scenario will not be part of 3GPP Rel-18 (e.g., left for future releases).
In addition, for the “known applications” scenario, the solution #9 under discussion is based on data collection from only two sources: NEF (PFDF) and UPF. However, based on current encryption trends, it will be difficult to derive new/updated PFDs for the “known applications” scenario based on UPF traffic analysis.
It is very important for the mobile network operator (MNO) to identify all the traffic traversing its network. But, traffic classified by UPF into the default PDR is unknown to MNO and there is currently no accurate mechanism to identify which application/s it pertains to.
Collaborative solutions like PFD Management are not yet deployed. In the future, assuming they are deployed, only a few content providers are likely to implement them, e.g., there will always be a lot of content providers not interested in helping MNOs to detect their traffic.
User traffic today is mostly encrypted (HTTPS, QUIC, etc.) and the trend goes towards more and more encryption (e.g., ECH, dual proxy deployments like Private relay, etc.), so it is not possible for UPF to identify traffic based on PFD rules (e.g., domain names are useless when there is ECH or DNS encryption).

The techniques described herein extend the analytics related to NWDAF-assisted application detection by triggering data collection from a new entity (acting as AF intermediary), which will hide the complexity towards external entities that might provide information relative to application traffic (e.g., Google Play Store, Apple App Store, Microsoft Store, IANA registries, Google Search, etc.).

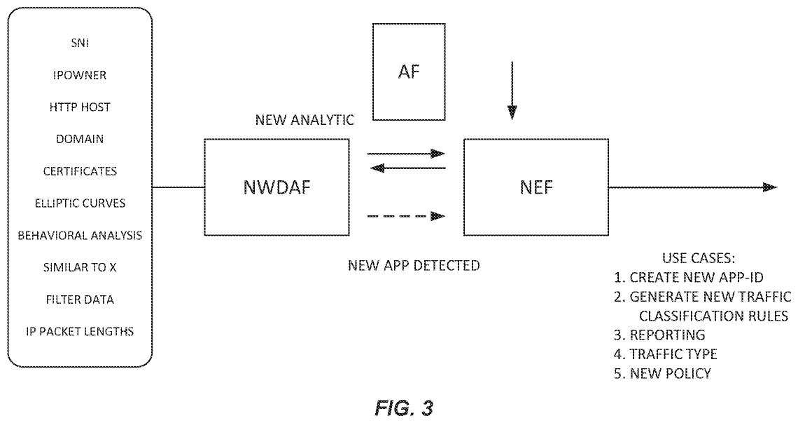

The mechanism on which these techniques are based is summarized in FIG. 3. For this analytic, NWDAF collects data from UPF (specifically traffic characteristics like those examples shown in the figure, for non-classified traffic), and then collects data (through the AF further described below and the NEF) from external sources by using as input the traffic characteristics previously collected from UPF.

In more detail, the approach may be summarized as follows. First, a new entity (acting as AF intermediary) registers in NRF as an AF including its capabilities, specifically a new service relative to providing information on application/s based on traffic characteristics. Subsequently, a Consumer requests or subscribes to an analytic ID for Assisted Application Detection. Two different scenarios are possible:
“Known applications” scenario. In this case, the MNO (e.g., NEF as consumer) is interested in detecting new PFDs (or updating PFDs) for the application/s of interest.
“Unknown applications” scenario. In this case, the MNO (e.g., Business Intelligence as consumer) is interested in detecting new applications (and their corresponding PFDs).

The NWDAF triggers data collection from UPF in order to retrieve traffic characteristics (on a per flow basis) for traffic matching the default UL/DL PDR. Specifically, this may include (not a complete list):
5-tuple
SNI
IP owner
HTTP Host
Domain
Certificates
Elliptic Curves
Behavioral analysis
Filter Data, e.g., IP packet lengths
L7 protocol
Content-type
Encoding
Connection information
User-agent
Last detected applications for IP user
ALPN protocol parameters

The NWDAF decides to apply the enhanced procedure for assisted application detection and triggers discovery of the AF entity supporting the new service, i.e., the new service relative to providing information on application/s based on traffic characteristics. The NWDAF triggers data collection from the discovered AF entity. For example, it might trigger a request on a per flow basis including as filter information the traffic characteristics obtained from UPF in the list above.

Based on the filter information and the values in each field, the AF entity selects which external entity/ies to query (e.g., through NEF), e.g., Google Play Store, Apple App Store, Microsoft Store, IANA registries, Google Search, etc. The retrieve information will differ depending on the entity selected. The AF has the capacity to launch queries to retrieve the information from a defined target (DB, a navigator, store, company repository, etc.). The AF consists of a set of developed functions that have the availability to query to a set of defined APIs. In order to retrieve new external information, a new function should be created.

The external entity/ies return data (e.g., server IP addresses, SNIs, DNS server/s), in response to queries from the AF. Based on the data collected, specifically data collected from AF entity, the NWDAF runs analytic processes and enriches the ML model to detect new applications and/or PFDs (depending on the “known” or “unknown” application scenario).

The consumer may then applies the following actions:
For the “known applications” scenario, the consumer (e.g., NEF) stores the derived PFDs in the UDR (e, g, as Application Data).
For the “unknown applications” scenario, the consumer (e.g., Business Intelligence) retrieves the new applications detected and based e.g., on their relative volume, it decides to create a new bundle offering.

The derived PFDs are distributed to the UPFs (e.g., through SMF) to match incoming traffic.

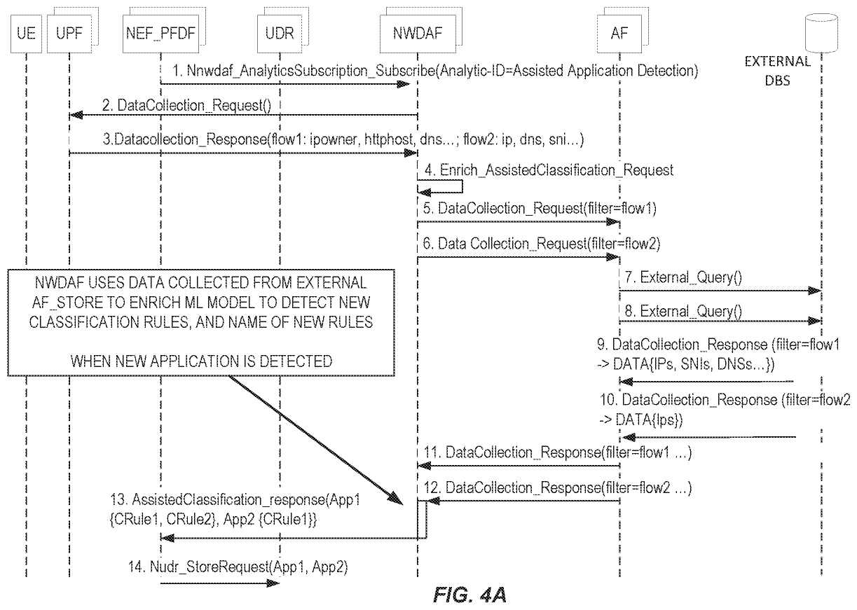

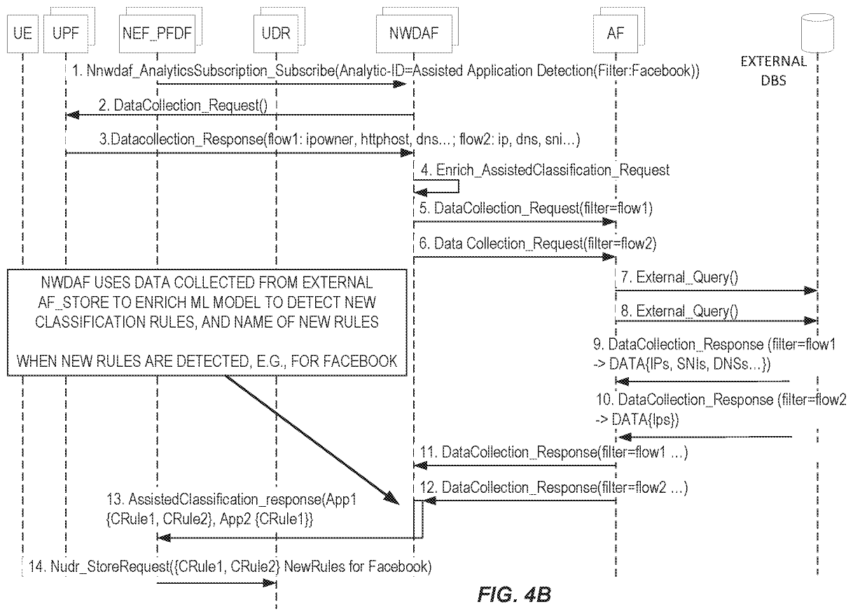

FIG. 4A and FIG. 4B are sequence diagrams illustrating an example of the technique, for “new” and “existing” applications, respectively, which can be understood as corresponding to the “unknown applications” and “known applications” scenarios discussed above.

FIG. 4 illustrates the “unknown applications” scenario. As a precondition for the subsequent steps, the “new” AF entity registers in NRF by triggering a Nnrf_Registration Request message including the following information:
NF_Type=AF
(A new) Service=Service-ID, corresponding to a new service relative to providing information on application/s based on traffic characteristics.

The NRF stores (as part of the NFprofile for AF) the information received, including the supported service/capabilities.

As shown at step 1 in FIG. 4A, a consumer, e.g., NEF/PFDF acting as a consumer network function (cNF), subscribes to the NWDAF analytic on assisted application detection (Analytic-ID=AssistedApplicationDetection), by triggering a Nnwdaf_AnalyticsSubscription_Subscribe request message including certain parameters, such as area of interest (AOI), Single-Network Slice Selection Assistance Information (S-NSSAI), domain network name (DNN), as Analytic-Filter.

As shown at step 2, the analytic request triggers, in the NWDAF, the data collection process. The NWDAF determines which data that is required and whether that data is already available (e.g., in ADRF) or whether it should now send any requests to collect the required data. In the illustrated case, NWDAF triggers data collection from UPF to retrieve traffic characteristics (on a per-flow basis) for traffic matching the default UL/DL PDR.

As shown at step 3, the UPF returns (on a per-flow basis) traffic characteristics, such as (not a complete list):
5-tuple
SNI
IP owner
HTTP Host
Domain
Certificates
Elliptic Curves
Behavioral analysis
Filter Data, e.g., IP packet lengths
L7 protocol
Content-type
Encoding
Connection information
User-agent
Last detected applications for IP user
ALPN protocol parameters
etc.
This is shown in FIG. 4A for two flows: flow1 and flow2)

As shown at step 4, the NWDAF then decides to apply the enhanced procedure for assisted application detection. Based on the above, the NWDAF triggers discovery of the AF entity supporting the new service described above (service relative to providing information on application/s based on traffic characteristics).

At steps 5 and 6, the NWDAF triggers data collection from the discovered AF entity, e.g., it might trigger a request on a per flow basis including as filter information the traffic characteristics obtained from the UPF in step 3 above. In the example, two request messages are sent (corresponding to two different flows matching the default UL/DL PDR).

As shown at steps 7 and 8, based on the filter information above, the values in each field, AF entity selects which external entity/ies to query (e.g., through NEF), e.g., Google Play Store, Apple App Store, Microsoft Store, IANA registries, Google Search, etc. The retrieve information will differ depending on the entity selected. AF has the capacity to launch queries to retrieve the information from a defined target (DB, a navigator, store, company repository, etc.). The AF consists of a set of developed functions that have the availability to query to a set of defined APIs. To retrieve new external information, new functions should be created.

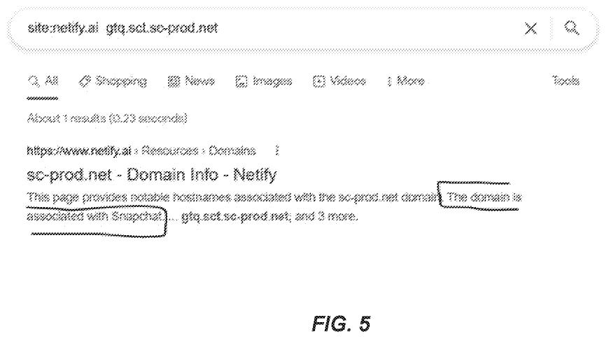

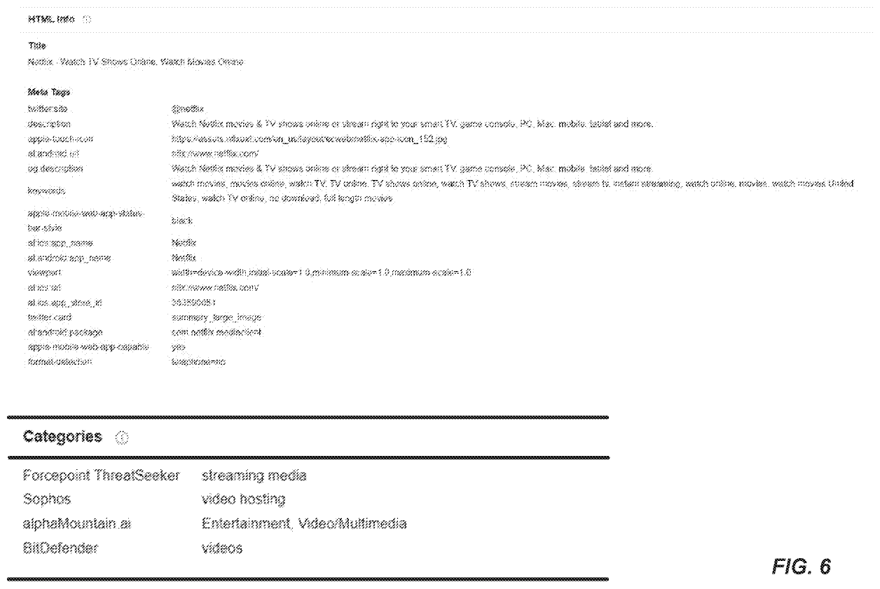

As shown at steps 9, 10, 11 and 12, external entity/ies return data (e.g., server IP addresses, SNIs, DNS server/s) and AF entity forwards that information to NWDAF. As an example, a Google Search for a certain site/domain (e.g., netify.ai) might return an output which provides information on the corresponding application (e.g., Snapchat). This output (e.g., in JSON or XML format) might be processed by the AF entity through a natural language processor to retrieve the application identifier (e.g., Snapchat). An example of the information returned from the external entity in this case is shown in FIG. 5. As another example, the screen capture shown in FIG. 6 shows an example of the output of a query for a certain SNI, e.g., Netflix.com, to an external API.

Returning to the sequence diagram in FIG. 4A, as shown at step 12, the NWDAF runs analytic processes and enriches the ML model to detect new application/s (“unknown” application scenario), based on the data collected and specifically based on the data collected from AF entity. As shown at step 13, the NWDAF then answers the consumer including the AnalyticResult, which includes the new application/s detected and their corresponding PFDs. As shown at step 14, the consumer, e.g., NEF/PFDF acting as cNF, stores in UDR both the new application/s and their corresponding PFDs by triggering a Nudr_Store Request message.

FIG. 4B shows a similar example process for the “known applications” scenario. Again, ss a precondition for the subsequent steps, the “new” AF entity registers in NRF by triggering a Nnrf_Registration Request message including the following information:
NF_Type=AF
(A new) Service=Service-ID, corresponding to a new service relative to providing information on application/s based on traffic characteristics.
   The NRF stores (as part of the NFprofile for AF) the information received, including the supported service/capabilities.

As shown at step 1 in FIG. 4B, a consumer (e.g., NEF/PFDF acting as cNF) subscribes to NWDAF analytic on assisted application detection (Analytic-ID=AssistedApplicationDetection), by triggering a Nnwdaf_AnalyticsSubscription_Subscribe request message including the (known) applications of interest (e.g., Facebook) and certain parameters (e.g., AOI, S-NSSAI, DNN) as Analytic-Filter.

As shown at step 2, the analytic request triggers, in the NWDAF, the data collection process. The NWDAF determines which data that is required and whether that data is already available (e.g., in ADRF) or whether it should now send any requests to collect the required data. In the illustrated case, NWDAF triggers data collection from UPF to retrieve traffic characteristics (on a per-flow basis) for traffic matching the default UL/DL PDR.

As shown at step 3, the UPF returns (on a per-flow basis) traffic characteristics, such as (not a complete list):
5-tuple
SNI
IP owner
HTTP Host
Domain
Certificates
Elliptic Curves
Behavioral analysis
Filter Data, e.g., IP packet lengths
L7 protocol
Content-type
Encoding
Connection information
User-agent
Last detected applications for IP user
ALPN protocol parameters
etc.
This is shown in FIG. 4B for two flows: flow1 and flow2)

As shown at step 4, the NWDAF then decides to apply the enhanced procedure for assisted application detection. Based on the above, the NWDAF triggers discovery of the AF entity supporting the new service described above (service relative to providing information on application/s based on traffic characteristics).

At steps 5 and 6, the NWDAF triggers data collection from the discovered AF entity, e.g., it might trigger a request on a per flow basis including as filter information the traffic characteristics obtained from the UPF in step 3 above. In the example, two request messages are sent (corresponding to two different flows matching the default UL/DL PDR).

As shown at steps 7 and 8, based on the filter information above, the values in each field, AF entity selects which external entity/ies to query (e.g., through NEF), e.g., Google Play Store, Apple App Store, Microsoft Store, IANA registries, Google Search, etc. The retrieve information will differ depending on the entity selected. AF has the capacity to launch queries to retrieve the information from a defined target (DB, a navigator, store, company repository, etc.). The AF consists of a set of developed functions that have the availability to query to a set of defined APIs. To retrieve new external information, new functions should be created.

As shown at steps 9, 10, 11 and 12, external entity/ies return data (e.g., server IP addresses, SNIs, DNS server/s) and AF entity forwards that information to NWDAF.

As shown at step 12, the NWDAF runs analytic processes and enriches the ML model to detect new/updated PFDs for the application/s of interest (“known” application scenario). This is based on the data collected by the NWDAF, specifically data collected from the new AF entity.

As shown at step 13, the NWDAF answers the consumer, including the AnalyticResult, which includes the new/updated PFDs for the application/s of interest. As shown at step 14, the consumer (e.g., NEF/PFDF acting as cNF) stores in UDR the new/updated PFDs for the application/s of interest by triggering a Nudr_Store Request message.

Finally, while not shown in the sequence diagram of FIG. 4B, the consumer (e.g., NEF/PFDF acting as cNF) may distribute the derived PFDs to the UPF/s (e.g., through SMF). The UPFs activate the PFDs to match incoming traffic.

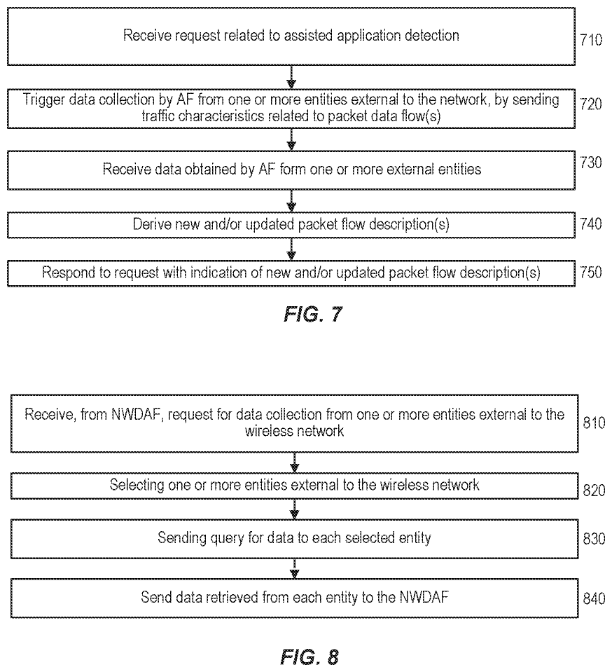

In view of the examples and details provided above, it will be appreciated that FIG. 7 is a process flow diagram illustrating a method, in a network data analytics function (NWDAF), for discovering and/or updating packet flow descriptions (PFDs) for network analytics in a wireless communication network. This example process flow is intended to be a generalization of and to encompass the techniques described above, from the perspective of the NWDAF. Thus, where terminology used in the below description differs from similar terms or concepts above, the former should be understood to be a generalization of and to encompass the latter. Similarly, the variations described in connection with FIGS. 4A and 4B above should be considered as pertaining to the example method shown here, even if not specifically referenced below.

The method comprises, as shown at block 710, the step of receiving, from a network analytics consumer, a request related to assisted application detection. As shown at block 720, the method further comprises triggering data collection by an application function (AF) from one or more entities external to the wireless communication network, responsive to the request, by sending traffic characteristics related to at least one packet data flow.

As shown at block 730, the method further comprises receiving, from the AF, data obtained by the AF from the one or more entities and corresponding to the traffic characteristics. This may comprise server-identifying data, such as server IP addresses, SNIs, DNS server identifiers, etc.

As shown at blocks 740 and 750, the method further comprises deriving one or more new and/or updated packet flow descriptions, based on the data received from the AF, and responding to the request with analytics results including an indication of the new and/or updated packet flow descriptions.

In some embodiments or instances of the illustrated method, the request indicates one or more applications of interest and the deriving one or more new and/or updated packet flow descriptions comprises deriving one or more new and/or updated packet flow descriptions corresponding to the one or more applications of interest. This corresponds to the “known applications” scenario. In other embodiments or instances, the deriving shown at block 740 comprises detecting one or more new applications, based on the data, and deriving one or more new packet flow descriptions for each of the new applications. In this case, an indication of the detected new applications may be included, along with their corresponding packet flow descriptions, in the analytics results.

In some embodiments or instances, the method comprises collecting traffic characteristics data from a user plane function (UPF), responsive to the request shown at block 710, and determining to trigger the data collection by the APF, as shown at block 720, based on the collected traffic characteristics data. In some instances or embodiments, this determining may be based on determining that (a) the enhanced procedure for assisted application detection is enabled, and (b) there is at least an AF (supporting the service relative to providing information on application/s based on traffic characteristics) registered in NRF. In some embodiments or instances, collecting traffic characteristics data from the UPF comprises retrieving any one or more of any of the following parameters or identifiers from the UPF, on a per-flow basis, for traffic matching a default uplink/downlink packet detection rule (PDR): 5-tuple; SNI; IP owner; HTTP Host; Domain; Certificates; Elliptic Curves; Behavioral analysis; Filter Data, e.g., IP packet lengths; L7 protocol; Content-type; Encoding; Connection information; User-agent; Last detected applications for IP user; and ALPN protocol parameters.

FIG. 8 is a process flow diagram illustrating a method, in an application function (AF), for supporting the discovery of and/or updating of packet flow descriptions (PFDs) for network analytics in a wireless communication network. Like FIG. 7, this example process flow is intended to be a generalization of and to encompass the techniques described above, but from the perspective of the AF. So, where terminology used in the below description differs from similar terms or concepts above, the former should be understood to be a generalization of and to encompass the latter. Similarly, the variations described in connection with FIGS. 4A and 4B above should be considered as pertaining to the example method shown here, even if not specifically referenced below.

The method comprises, as shown at block 810, receiving, from a network data analytics function (NWDAF), a request for data collection by the AF from one or more entities external to the wireless communication network, the request including traffic characteristics related to at least one packet data flow. As shown at block 820, the method further comprises selecting one or more entities external to the wireless communication network, based on the traffic characteristics. This is a broad step, as as there might be many different criteria. For example, for an iPhone UE, the AF would query Apple App Store, instead of the Google Play Store as discussed in some examples above. If traffic characteristics (from UPF) include a server IP address, the AF might query IANA registries. If traffic characteristics (from UPF) include a string (e.g., domain name), AF might query Google Search, etc.

As shown at blocks 830 and 840, the method further comprises sending a query for data corresponding to the traffic characteristics to each selected entity, and sending data retrieved from each selected entity to the NWDAF. As discussed in some examples above, this might be an IP address, e.g., as obtained from IANA registries, or a string corresponding to a domain name.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

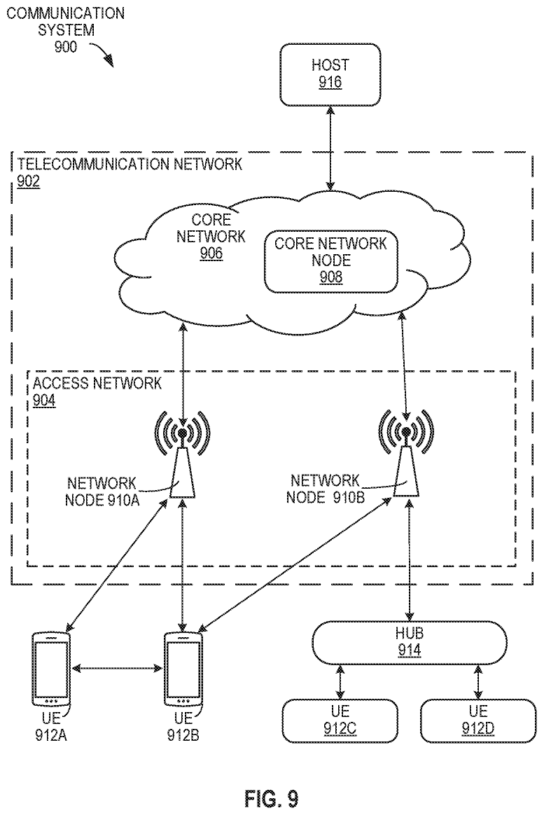

FIG. 9 shows an example of a communication system 900 in accordance with some embodiments. In this example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3GPP access node or non-3GPP access point. The network nodes 910 facilitate direct or indirect connection of UEs, such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Analytics Data Repository Function (ADRF), network repository function (NRF), network data analytics function (NWDAF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the bub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub-that is, a hub whose primary function is to route communications to/from the UEs from/to the network node 910b. In other embodiments, the hub 914 may be a non-dedicated hub-that is, a device which is capable of operating to route communications between the UEs and network node 910b, but which is additionally capable of operating as a communication start and/or end point for certain data channels.

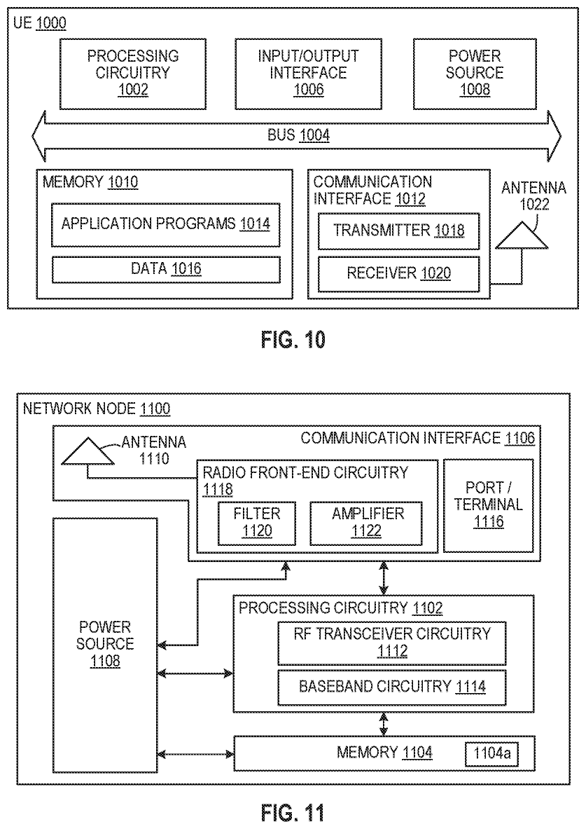

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VolP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions (collectively denoted computer program product 1104a) capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

In various embodiments, network node 1100 (and its constituent components) can be configured to perform operations comprising various methods described herein, such as methods performed by a gateway exposure function (GEF), network repository function (NRF), and network data analytics function (NWDAF).

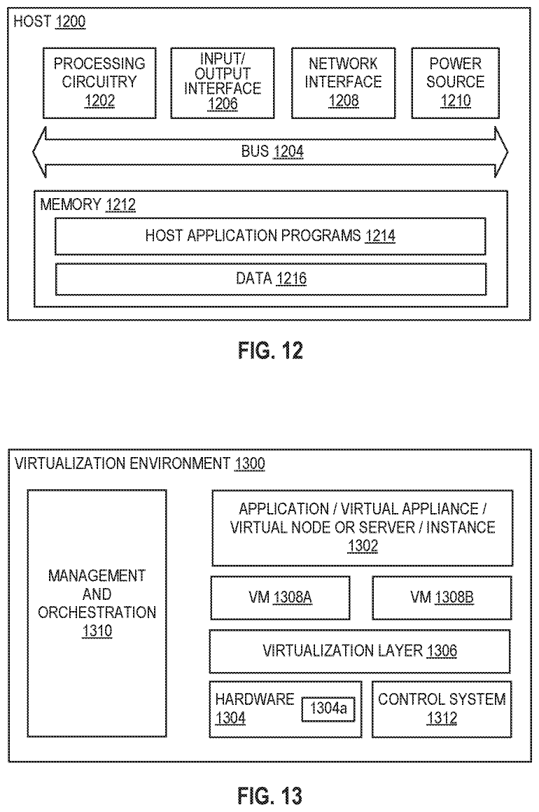

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein. For example, in various embodiments, various gateway exposure functions (GEF), network repository functions (NRF), and network data analytics functions (NWDAF) described herein can be instantiated as virtual NFs in environment 1300, such that each instantiation performs operations corresponding to methods (or procedures) described elsewhere herein.

Hardware 1304 includes processing circuitry, memory that stores software and/or instructions executable by hardware processing circuitry (collectively denoted computer program product 1304a), and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g., such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

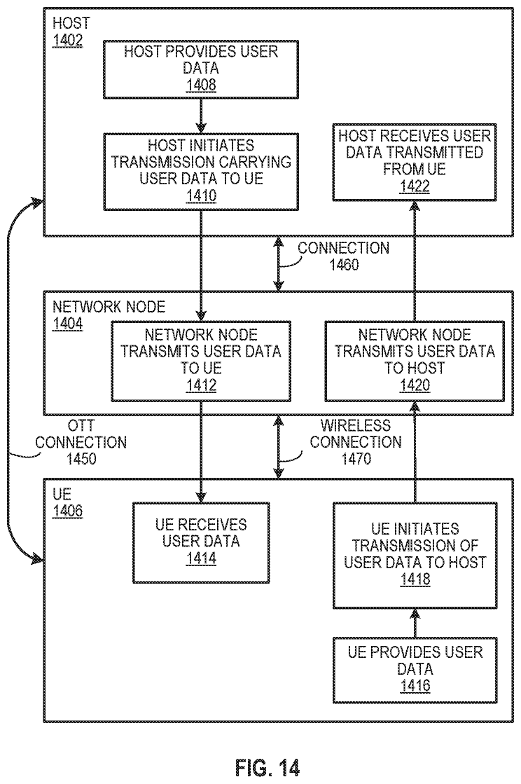

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, embodiments can enable an ADRF (or other data repository) to easily verify whether a data consumer network function (NFc) is authorized to access and receive analytics data and/or models that have been collected from a data producer network function (e.g., NWDAF) and stored in ADRF. This prevents ADRF from distributing proprietary and/or sensitive data to an unauthorized and/or “rogue” prospective NFc. Thus, embodiments can improve security of analytics and/or models used in 5G networks. Improved network security can increase the value of OTT services delivered via the network to both service providers and end users.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties. If the publications have different versions, the most recent version as of the filing date of this application is intended.

1-14. (canceled)

15. A method, in a network data analytics function (NWDAF), for discovering and/or updating packet flow descriptions (PFDs) for network analytics in a wireless communication network, the method comprising:
receiving, from a network analytics consumer, a request related to assisted application detection;
triggering data collection by an application function (AF) from one or more entities external to the wireless communication network, responsive to the request, by sending traffic characteristics related to at least one packet data flow;
receiving, from the AF, data obtained by the AF from the one or more entities and corresponding to the traffic characteristics;
based on the data, deriving one or more new and/or updated packet flow descriptions; and
responding to the request with analytics results including an indication of the new and/or updated packet flow descriptions.

16. The method of claim 15, wherein:
said request indicates one or more applications of interest; and
said deriving one or more new and/or updated packet flow descriptions comprises deriving one or more new and/or updated packet flow descriptions corresponding to the one or more applications of interest.

17. The method of claim 15, wherein:
said deriving comprises detecting one or more new applications, based on the data, and deriving one or more new packet flow descriptions for each of the new applications; and
including an indication of the detected new applications, along with their corresponding packet flow descriptions, in the analytics results.

18. The method of claim 15, wherein the method comprises collecting traffic characteristics data from a user plane function (UPF), responsive to the request, and determining to trigger data collection by the AF from one or more entities external to the wireless communication network based on the collected traffic characteristics data.

19. The method of claim 18, wherein said collecting traffic characteristics data from the UPF comprises retrieving any one or more of any of the following from the UPF, on a per-flow basis, for traffic matching a default uplink/downlink packet detection rule (PDR):
5-tuple;
SNI;
IP owner;
HTTP Host;
Domain;
Certificates;
Elliptic Curves;
Behavioral analysis;
Filter Data;
L7 protocol;
Content-type;
Encoding;
Connection information;
User-agent;
Last detected applications for IP user; and
ALPN protocol parameters.

20. A method, in an application function (AF), for supporting the discovery of and/or updating of packet flow descriptions (PFDs) for network analytics in a wireless communication network, the method comprising:
receiving, from a network data analytics function (NWDAF), a request for data collection by the AF from one or more entities external to the wireless communication network, the request including traffic characteristics related to at least one packet data flow;
selecting one or more entities external to the wireless communication network, based on the traffic characteristics;
sending a query for data corresponding to the traffic characteristics to each selected entity; and
sending data retrieved from each selected entity to the NWDAF.

21. A network data analytics function (NWDAF) of a communication network, wherein:
the NWDAF is implemented by communication interface circuitry and processing circuitry that are operably coupled and configured to communicate with other nodes and functions of the communication network; and
the processing circuitry and the communication interface circuitry are further configured to
receive, from a network analytics consumer, a request related to assisted application detection;
trigger data collection by an application function (AF), from one or more entities external to the wireless communication network, responsive to the request, by sending traffic characteristics related to at least one packet data flow;
receive, from the AF, data obtained by the AF from the one or more entities and corresponding to the traffic characteristics;
based on the data, deriving one or more new and/or updated packet flow descriptions; and
respond to the request with analytics results including an indication of the new and/or updated packet flow descriptions.

22. The NWDAF according to claim 21, wherein
said request indicates one or more applications of interest; and
said deriving one or more new and/or updated packet flow descriptions comprises deriving one or more new and/or updated packet flow descriptions corresponding to the one or more applications of interest.

23. The NWDAF according to claim 21, wherein
said deriving comprises detecting one or more new applications, based on the data, and deriving one or more new packet flow descriptions for each of the new applications; and
including an indication of the detected new applications, along with their corresponding packet flow descriptions, in the analytics results.

24. The NWDAF according to claim 21, wherein the processing circuitry and the communication interface circuitry are further configured to
collect traffic characteristics data from a user plane function (UPF), responsive to the request, and determining to trigger data collection by the AF from one or more entities external to the wireless communication network based on the collected traffic characteristics data.

25. The NWDAF according to claim 24, wherein said collecting traffic characteristics data from the UPF comprises retrieving any one or more of any of the following from the UPF, on a per-flow basis, for traffic matching a default uplink/downlink packet detection rule (PDR):
5-tuple;
SNI;
IP owner;
HTTP Host;
Domain;
Certificates;
Elliptic Curves;
Behavioral analysis;
Filter Data;
L7 protocol;
Content-type;
Encoding;
Connection information;
User-agent;
Last detected applications for IP user; and
ALPN protocol parameters.

26. An application function (AF) of a communication network, wherein:
the AF is implemented by communication interface circuitry and processing circuitry that are operably coupled and configured to communicate with other nodes and functions of the communication network; and
the processing circuitry and the communication interface circuitry are further configured to
receive, from a network data analytics function (NWDAF), a request for data collection by the AF from one or more entities external to the wireless communication network, the request including traffic characteristics related to at least one packet data flow;
select one or more entities external to the wireless communication network, based on the traffic characteristics;
send a query for data corresponding to the traffic characteristics to each selected entity; and
send data retrieved from each selected entity to the NWDAF.
